(19) United States
(12) Patent Application Publication
(10) Pub. No.: US 2025/0284443 A1
(43) Pub. Date: Sep. 11, 2025

(54) NON-TRANSITORY COMPUTER READABLE STORAGE MEDIUM AND INFORMATION PROCESSING APPARATUS

(71) Applicant: BROTHER KOGYO KABUSHIKI KAISHA, Nagoya (JP)

(72) Inventor: Satoshi MATSUSHITA, Nagoya (JP)

(21) Appl. No.: 19/070,796

(22) Filed: Mar. 5, 2025

(30) Foreign Application Priority Data
Mar. 6, 2024 (JP) 2024-034175

(51) Int. Cl. G06F 3/12

(52) U.S. Cl. CPC G06F 3/1253; G06F 3/1205; G06F 3/1259

(57) ABSTRACT

A non-transitory computer readable storage medium stores a program set including a resident first program and a non-resident second program. The second program, when executed by a processor, causes an information processing apparatus to perform second operations including: transmitting, to the image processing device, an execution instruction for causing a job related to image processing to be executed; and displaying a setting screen configured to receive a setting related to the first program. The first program, when executed by the processor, causes the information processing apparatus to perform first operations including: communicating, in accordance with the setting received on the setting screen displayed in the second operations, with the image processing device; acquiring information related to the image processing device through a communication with the image processing device; and displaying notification information based on the acquired information related to the image processing device.

### REFERENCE TO RELATED APPLICATIONS

This application claims priority from Japanese Patent Application No. 2024-034175 filed on Mar. 6, 2024. The entire content of the priority application is incorporated herein by reference.

### BACKGROUND ART

The technical field disclosed in the present specification relates to a non-transitory computer readable storage medium storing a program set, and an information processing apparatus, and particularly, the program set includes a resident program configured to acquire information related to an image processing device.

As an example of a resident program that functions as a resident process, which is resident after an information processing apparatus is activated and continues processing, there is a program for communicating with an image processing device to be monitored. For example, a status monitor caused to function by a resident program periodically communicates with a printer, acquires a status of the printer, and generates a notification of information indicating the status as necessary.

### DESCRIPTION

The resident program is resident after the information processing apparatus is activated, and the resident program continues to consume resources such as a memory. Therefore, there is room for improvement in regard to resource consumption of the resident program.

In an aspect of the present disclosure, there is provided a non-transitory computer readable storage medium storing a program set, the program set including a first program and a second program, the first program being a resident program, the second program being a non-resident program, wherein the second program, when executed by a processor of an information processing apparatus, causes the information processing apparatus to perform second operations, the second operations including: transmitting, to an image processing device via a communication device of the information processing apparatus, an execution instruction for causing a job related to image processing to be executed; and displaying a setting screen configured to receive a setting related to the first program, and wherein the first program, when executed by the processor, causes the information processing apparatus to perform first operations, the first operations including: communicating, in accordance with the setting received on the setting screen displayed in the second operations, with the image processing device via the communication device; acquiring information related to the image processing device through a communication with the image processing device; and displaying notification information based on the information related to the image processing device acquired in the acquiring the information related to the image processing device.

According to the technique disclosed in the present specification, separate from the resident first program for acquiring information related to the image processing device, the non-resident second program for transmitting an image processing execution instruction is provided to include the setting screen for the first program. Consequently, an amount of resources consumed by the first program can be reduced, whereby resources for displaying the setting screen for making a setting related to the first program can be efficiently used as compared with a case in which the setting screen is included in the first program.

An information processing apparatus configured to achieve the operations by the above device is also novel and useful.

According to the technique disclosed in the present specification, it is possible to achieve a technique of efficiently using resources of an information processing apparatus when a resident program is used.

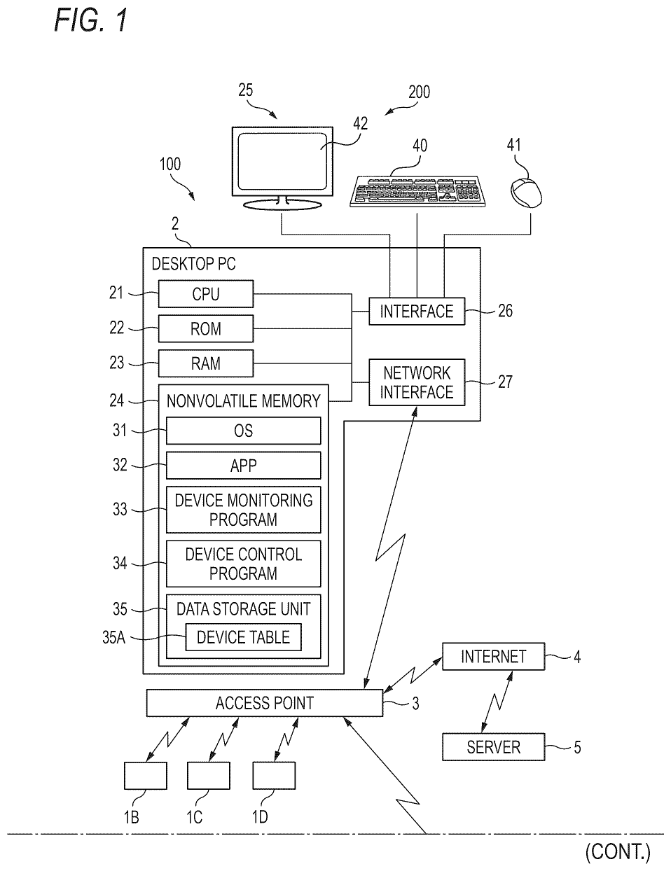

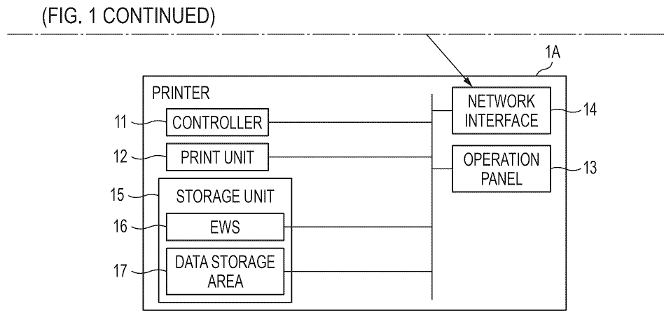

FIG. 1 is a schematic diagram of an information processing system according to a first embodiment.

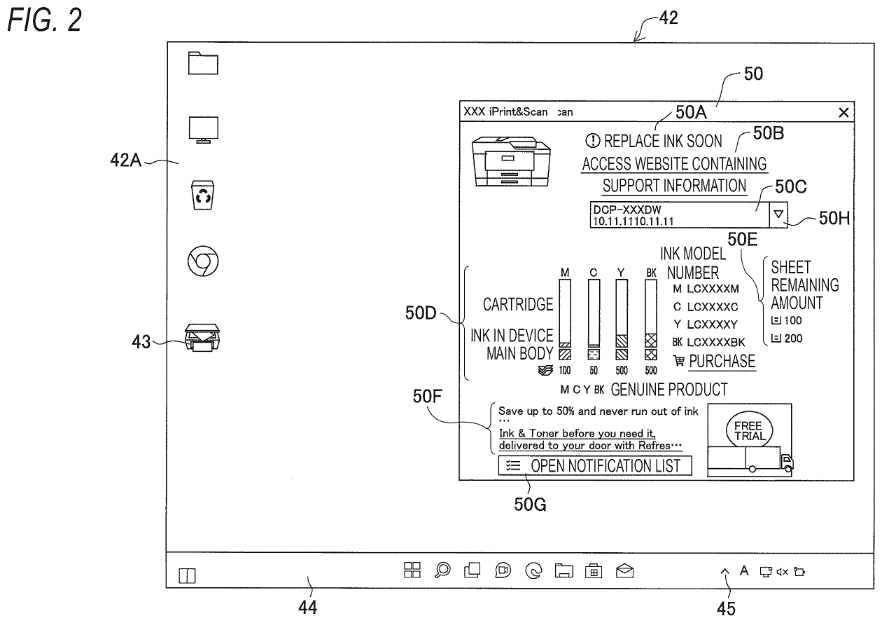

FIG. 2 is a diagram illustrating a display of an operation display unit in a state in which a first status information screen is displayed as a pop-up.

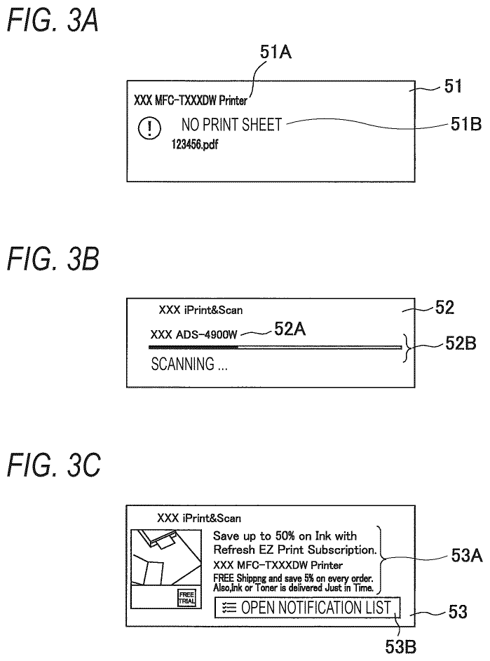

FIG. 3A is a diagram illustrating a second status information screen displayed as a pop-up on the display of the operation display unit; FIG. 3B is a diagram illustrating a third status information screen displayed as a pop-up on the display of the operation display unit; and FIG. 3C is a diagram illustrating an offering information screen displayed as a pop-up on the display of the operation display unit.

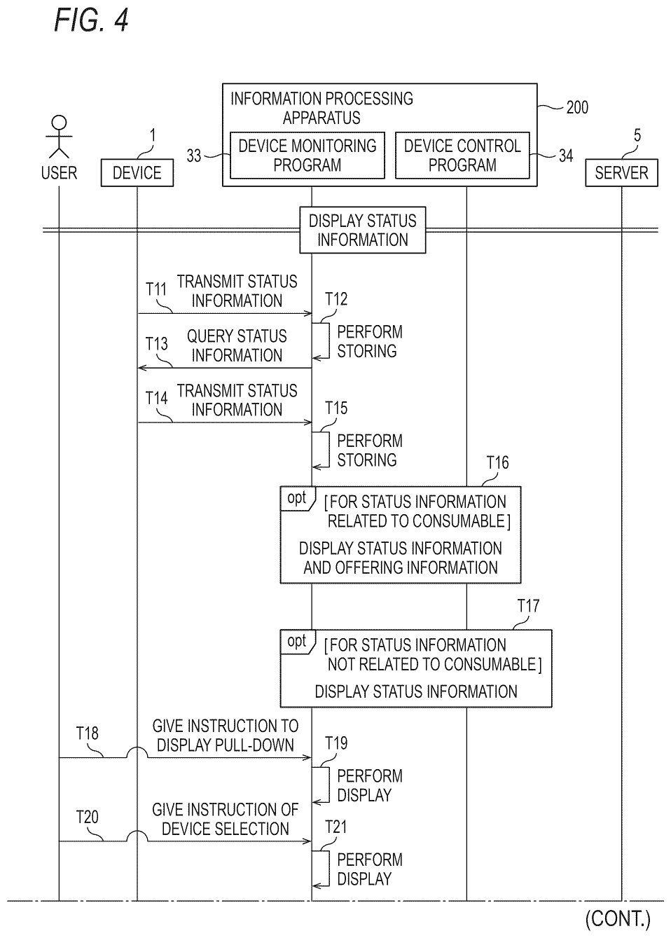

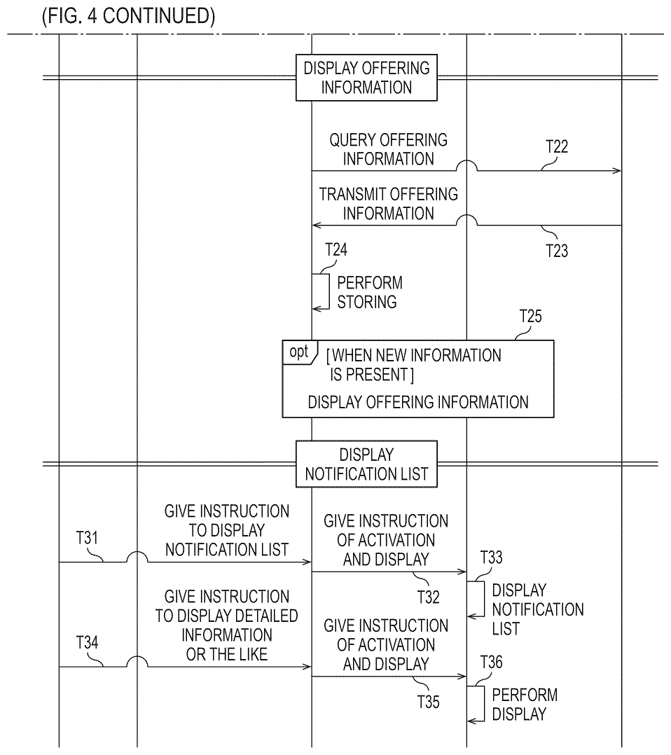

FIG. 4 is a sequence diagram illustrating an example of a procedure for display processing of status information, offering information, and a notification list, implemented by a device monitoring program of an information processing apparatus, including operations of a device and a server.

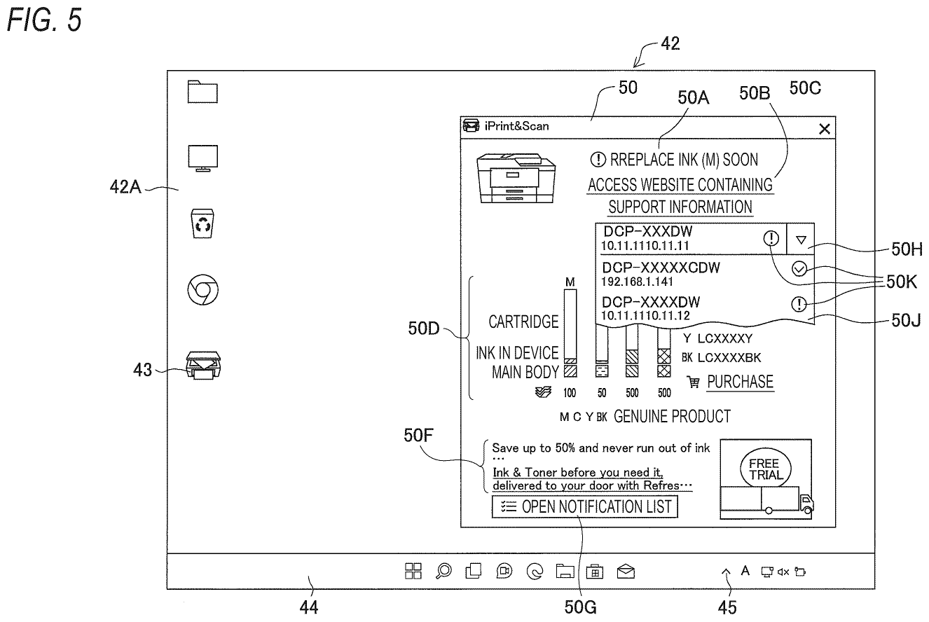

FIG. 5 is an operation diagram illustrating the display of the operation display unit in the state in which the first status information screen is displayed as a pop-up.

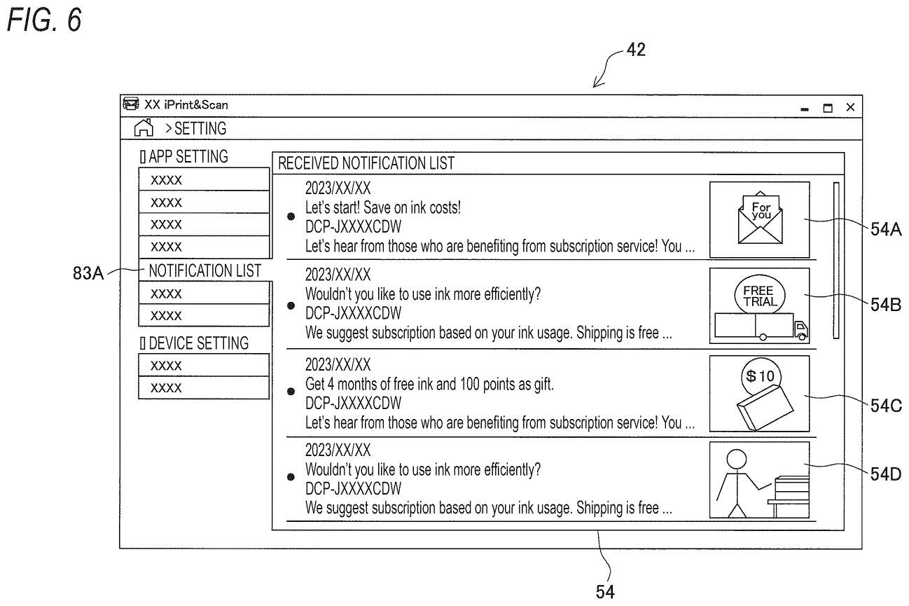

FIG. 6 is a diagram illustrating an example of a notification list screen.

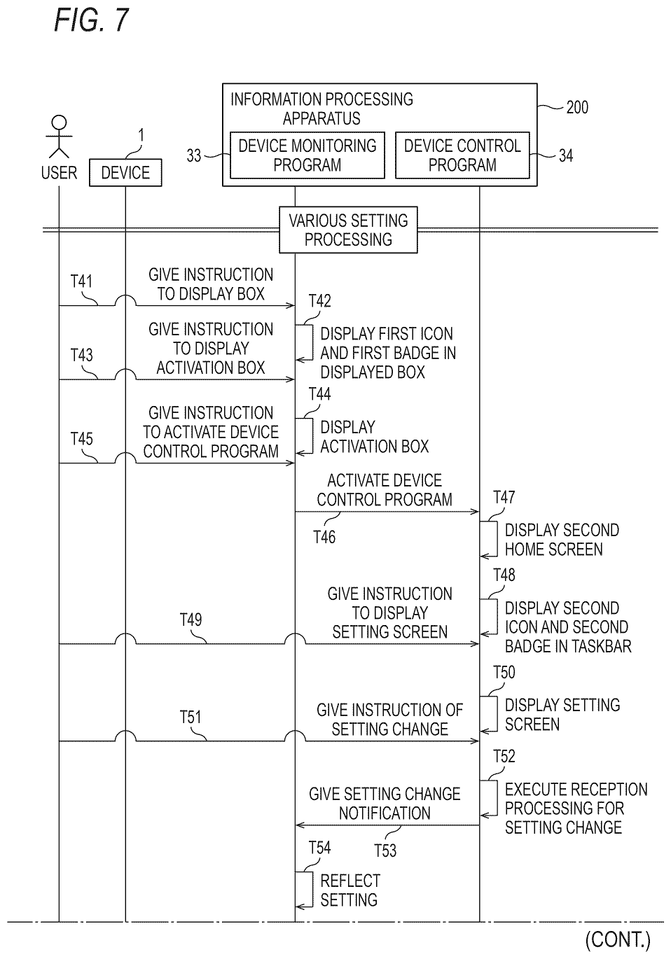

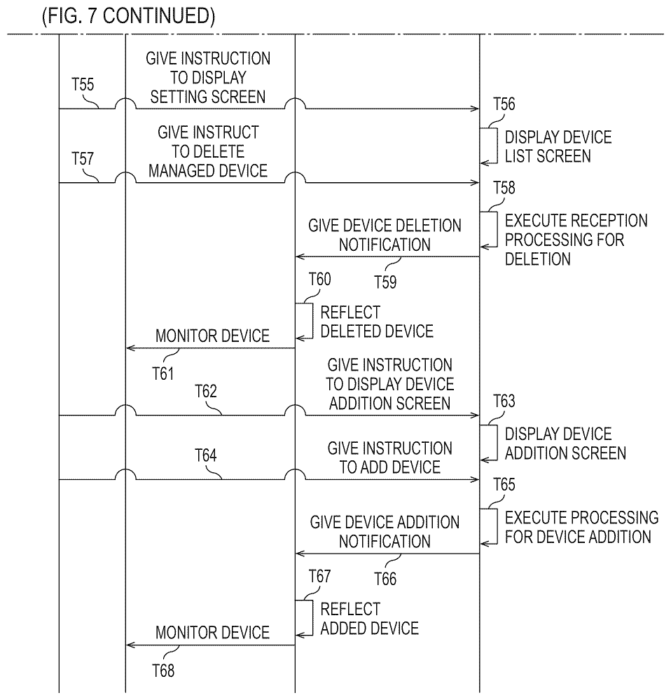

FIG. 7 is a sequence diagram illustrating an example of a procedure for various setting processing implemented by the device monitoring program and a device control program of the information processing apparatus, including operations of the device.

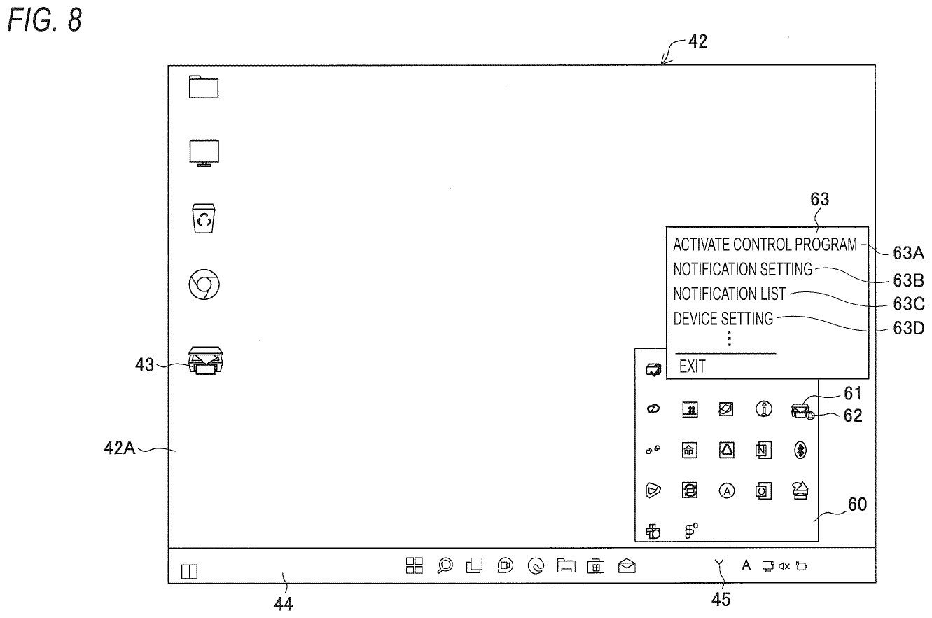

FIG. 8 is a diagram illustrating an example of the display in a state in which a box and an activation box are displayed as pop-ups.

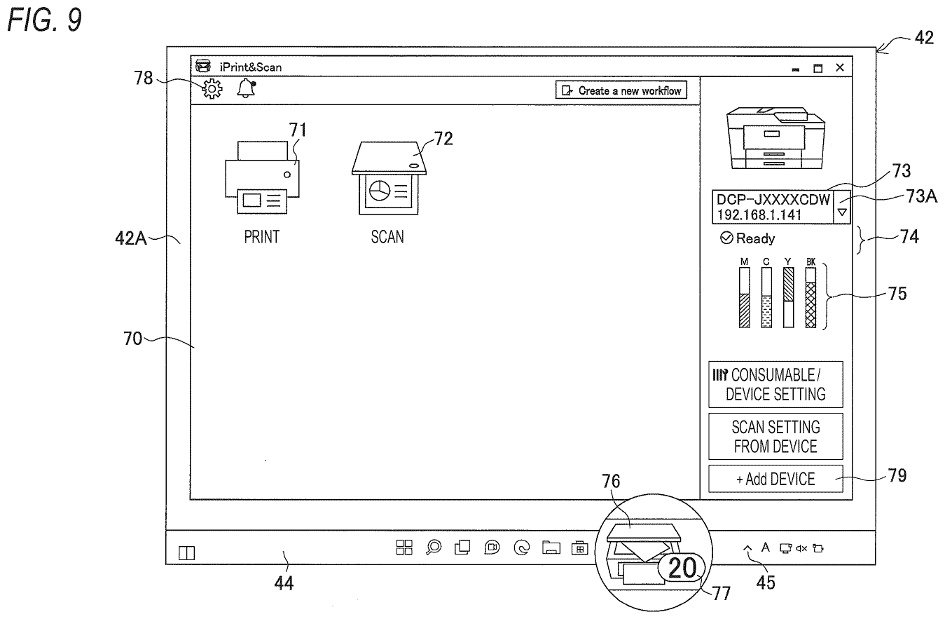

FIG. 9 is a diagram illustrating an example of the display in a state in which a second home screen displayed by the device control program is displayed.

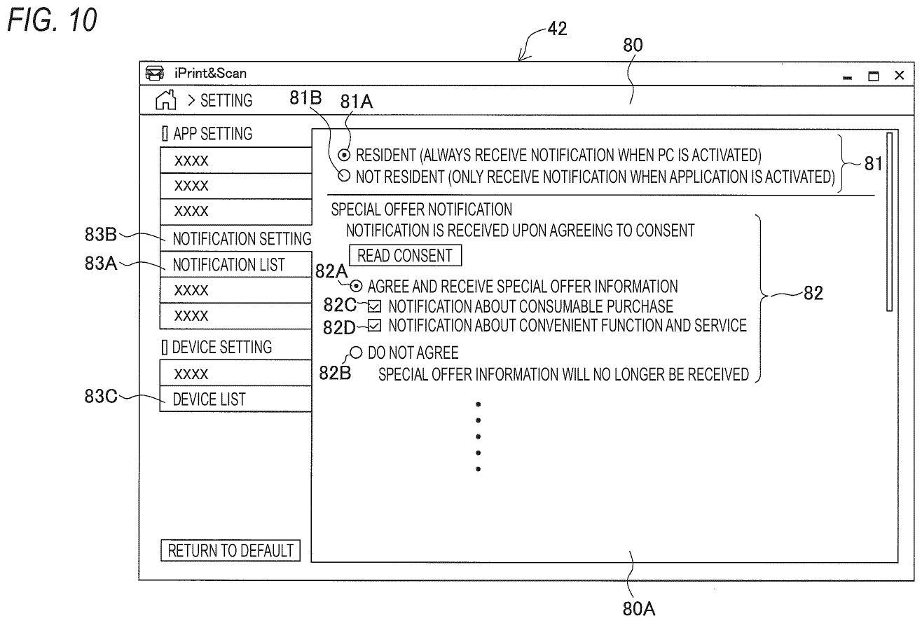

FIG. 10 is a diagram illustrating an example of the display in a state in which a setting screen is displayed.

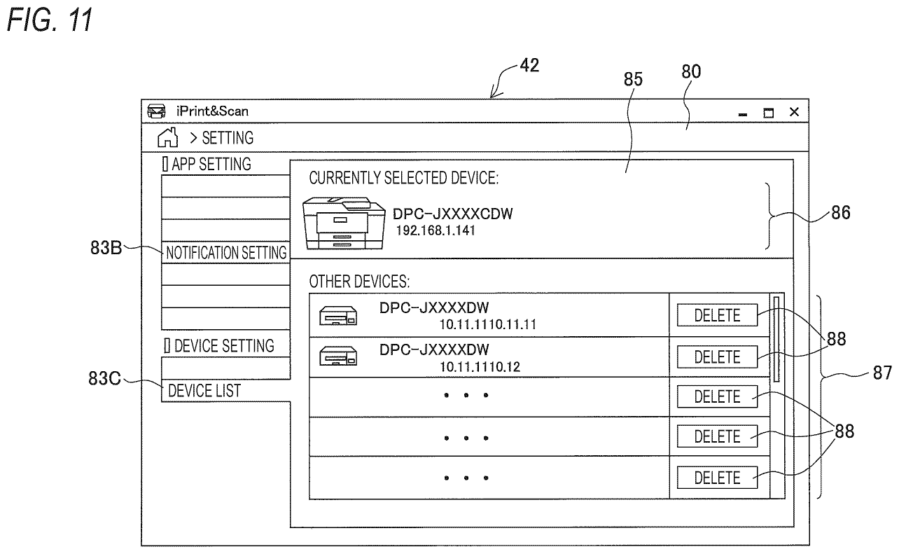

FIG. 11 is a diagram illustrating an example of the display in a state in which a device list screen is displayed.

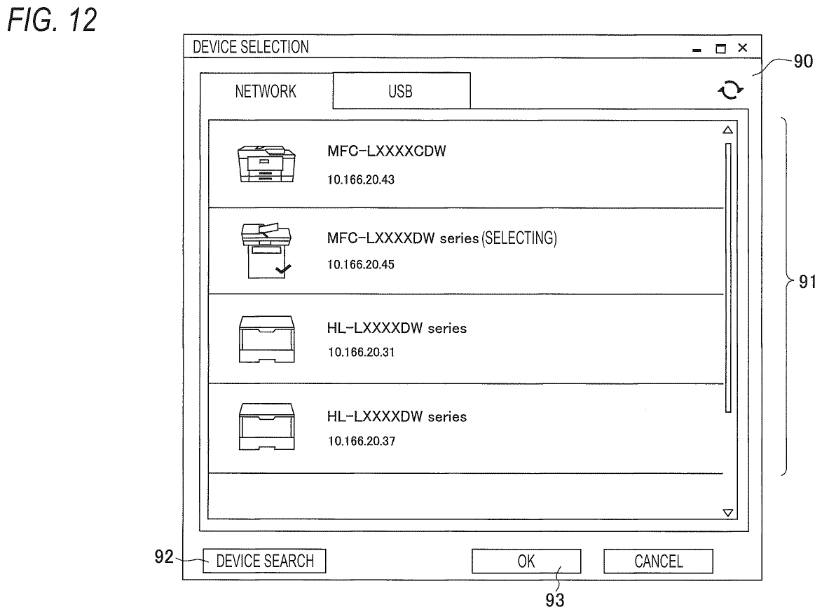

FIG. 12 is a diagram illustrating an example of the display in a state in which a device addition screen is displayed.

### First Embodiment

Hereinafter, a specific embodiment of an information processing system according to the present embodiment will be described in detail with reference to the accompanying drawings. In the present embodiment, the present disclosure is applied to the information processing system including a printer and an information processing apparatus that can communicate with each other.

That is, as illustrated in FIG. 1, an information processing system 100 according to the present embodiment includes four devices 1A, 1B, 1C, and 1D and an information processing apparatus 200, which are communicatively connected to each other. In the following description, when there is no need to distinguish between the devices 1A, 1B, 1C, and 1D, the subscripts for distinguishing A to D will be omitted and the devices will be described as a device 1. The device is an example of an image processing device.

The device 1 includes a printer 1A capable of printing on a medium to be printed, and an image reading device 1B capable of reading an image recorded on a medium to be read. In the present embodiment, the printer 1A is exemplified as an inkjet printer. As a modification, the printer 1A may be a laser printer, a label printer, a copier, or a multi function device. The information processing apparatus 200 generates and edits image data to be printed by the printer 1A, transmits a print execution instruction and the image data to the printer 1A, and receives status information from the printer 1A.

The information processing apparatus 200 transmits a reading execution instruction to the image reading device 1B, receives read data from the image reading device 1B, and receives status information from the image reading device 1B. The image reading device 1B may be a copier, a multi function device, or the like.

The information processing apparatus 200 is, for example, a smartphone, a personal computer, or a tablet computer. The number of information processing apparatus 200 constituting the information processing system 100 is not limited to one. A plurality of information processing apparatus may be provided.

As illustrated in FIG. 1, in the present embodiment, the printer 1A includes a controller 11, a print unit 12, an operation panel 13, a network interface 14, and a storage unit 15. The controller 11 includes a CPU and memories such as a flash ROM and a RAM, and controls each component of the printer 1A.

The controller 11 is a general term for hardware used to control the printer 1A, such as the CPU. Specifically, the controller 11 may also include an application specific integrated circuit (ASIC) and the like.

The print unit 12 is configured to print an image on a medium to be printed based on the image data transmitted from the information processing apparatus 200. In the present embodiment, an inkjet printing method is adopted as an image forming method of the print unit 12. The print unit 12 includes a print head that prints an image on a medium. Further, the print unit 12 may also be referred to as a print engine. The image forming method of the print unit 12 may be a thermal printing method or an electrophotographic method.

The operation panel 13 is, for example, a touch panel, receives an input from a user, and displays information. The operation panel 13 may include various display lamps, buttons, and the like.

The network interface 14 is hardware for communicating with the information processing apparatus 200.

The storage unit 15 of the printer 1A stores a program for an embedded web server (hereinafter, referred to as “EWS” (abbreviation of embedded web server)) 16. Further, the storage unit 15 has a data storage area 17, and the data storage area 17 stores, for example, capability information on the printer 1A, connection information for connecting to the printer 1A, status information on the printer 1A, various setting information set in the printer 1A, consumable remaining amount information on the printer 1A, printed sheet number information on the printer 1A, and consumable support-related information. For example, the information processing apparatus 200 can access various information stored in the data storage area 17 via the EWS 16. The printer 1A manages a print progress status for each transmission source of a job. In the present embodiment, the consumable is an ink cartridge that contains ink consumed in print processing of a printer, and the remaining amount information is information related to a remaining amount of ink contained in the ink cartridge.

The devices 1B to 1D also include an EWS similar to the EWS 16 of the printer 1A, and a storage unit (both not illustrated).

In the present embodiment, as illustrated in FIG. 1, the information processing apparatus 200 includes a desktop personal computer (PC) 2 and an input and output device 25. The desktop personal computer (PC) 2 includes a CPU 21, a ROM 22, a RAM 23, a non-volatile memory 24, an interface 26, and a network interface 27. The ROM 22 stores various programs and the like for the information processing apparatus 200. The RAM 23 is used as a work area when various processing is executed, or as a storage area for temporarily storing data. The non-volatile memory 24 is, for example, a hard disk drive (HDD), a solid state drive (SSD), a flash memory, or the like, and stores various programs and data.

The CPU 21 executes various processing according to programs loaded from the ROM 22 to the non-volatile memory 24.

The input and output device 25 is connected to the interface 26, and includes an input device and an output device. The input device includes a keyboard 40, a mouse 41, and the like. The output device includes a display 42. The display 42 is, for example, a liquid crystal display or an organic EL display. The input and output device 25 may be a touch panel that can be operated by touch. The information processing apparatus 200 may be a notebook PC or a tablet.

The network interface 27 is hardware for communicating with each device 1. The network interface 27 is an example of a communication unit.

In the information processing system 100 according to the present embodiment, the information processing apparatus 200 and each device 1 perform wireless communication conforming to a Wi-Fi (registered trademark) standard via a common access point 3. That is, the network interfaces 14 and 27 are both wireless interfaces that enable wireless communication based on the Wi-Fi (registered trademark) standard. The network interfaces 14 and 27 may be wired interfaces such as wired local area network (LAN) interfaces.

The communication mode according to the present embodiment is an example, and is not limited to the above mode. For example, the information processing apparatus 200 and each device 1 may communicate with each other by wireless communication through a direct connection without going through the access point 3, or by wired communication using an interface such as USB.

The access point 3 is connected to a server 5 provided by a manufacturer, a sales company, or the like of the device 1 via an Internet 4. Therefore, the information processing apparatus 200 can download a manual or the like of the device 1 from the server 5 via the Internet 4. In addition to the manual, offering information such as service information and bargain information related to a consumable of the device 1 can be downloaded from the server 5.

Examples of services related to the consumable include an automatic consumable delivery service and a subscription service. The automatic consumable delivery service is a service that automatically delivers a consumable to a user of the printer based on consumable remaining amount information. The subscription service is a service that charges a fixed amount for up to a predetermined number of printed sheets of the printer, and automatically delivers the consumable to the user of the printer based on the consumable remaining amount information.

As illustrated in FIG. 1, the non-volatile memory 24 of the information processing apparatus 200 stores an operating system (OS) 31, an application program (app) 32, a device monitoring program 33, and a device control program 34. Further, the non-volatile memory 24 includes a data storage unit 35.

The OS 31 is, for example, Windows (registered trademark), macOS (registered trademark), Linux (registered trademark), iOS (registered trademark), or Android (registered trademark). In the present embodiment, the OS 31 is Windows.

The app 32 is, for example, an image editing program having a function of receiving a user instruction via the interface 26, a function of displaying an image on the display 42, and a function of editing and saving the image. The app 32 may be a document editing program, a spreadsheet program, or the like.

The device monitoring program 33 is a resident program, and is a program for implementing a function of periodically communicating with each device 1 via the network interface 27 and acquiring various status information and the like from each device 1. Further, the device monitoring program 33 is a program for implementing a function of periodically communicating with the server 5 via the network interface 27 and acquiring various information from the server 5.

The resident program is, for example, a program that is automatically activated when the OS is activated and performs predetermined processing in a background during activation of the OS. The device monitoring program 33 is an example of a first program.

Specifically, the device monitoring program 33 acquires, from the printer 1A via the network interface 27, the capability information on the printer 1A, the connection information for connecting to the printer 1A, the status information on the printer 1A, the various setting information set in the printer 1A, the consumable remaining amount information on the printer 1A, the printed sheet number information on the printer 1A, the consumable support-related information, information on the print progress status, and the like, and stores the acquired information in the data storage unit 35.

Further, the device monitoring program 33 acquires, from the image reading device 1B via the network interface 27, capability information on the image reading device 1B, connection information for connecting to the image reading device 1B, status information on the image reading device 1B, various setting information set in the image reading device 1B, information related to a read progress status, and the like, and stores the acquired information in the data storage unit 35.

Further, the device monitoring program 33 acquires, via the network interface 27, the offering information related to the device 1 provided by the manufacturer or the sales company of the device 1, and stores the acquired offering information in the data storage unit 35. The offering information includes consumable-related service information and bargain information, maintenance information, notification of a campaign, a latest model, and introductions of convenient functions. Further, the offering information may include link information to the server 5. The offering information is an example of service-related information.

Then, the device monitoring program 33 can read the status information, the offering information, and the like of the device 1 stored in the data storage unit 35, and display the read information as a pop-up on the display 42.

The device control program 34 has a function of causing the printer 1A, which is set in a model name display field 73 described later, to print an image edited or stored by the app 32. That is, the device control program 34 receives a selection of an image to be printed, and transmits print data based on the selected image to the printer 1A, thereby causing the printer 1A to perform printing based on the print data. This function is an example of transmission processing. The status information, the consumable remaining amount information, and the like on the selected printer 1A can be read from the data storage unit 35 and displayed on the display 42. The device control program 34 is, for example, a non-resident program that is activated when activated and operated by the user. The device control program 34 is an example of a second program.

The device control program 34 instructs the selected image reading device 1B to read, receives image information read by the selected image reading device 1B, and stores the image information in the data storage unit 35. This function is an example of transmission processing. Further, information related to a read progress status of the selected image reading device 1B can be read from the data storage unit 35 and then displayed on the display 42.

The data storage unit 35 is provided with a device table 35A. The device table 35A stores model names, model numbers, and the like of all the devices 1 to be monitored by the device monitoring program 33.

FIG. 2 is a diagram illustrating an example of a display state of the display 42 in a state in which a first status information screen 50 by the device monitoring program 33 is displayed as a pop-up. That is, on a first home screen 42A of the information processing apparatus 200, an icon 43 for the user to activate the device control program 34 is displayed on a left side of the display 42, and a taskbar 44 is displayed on a lower side of the display 42. A box display button 45 is displayed on a right side of the taskbar 44. The icon 43 for the device control program 34 is not required to be displayed on the first home screen 42A, and the device control program 34 may be activated by an operation on a menu screen of the information processing apparatus 200 (not illustrated).

The first home screen 42A is displayed on the display 42 by the OS, and on the first home screen 42A, the icon 43, the taskbar 44, the box display button 45, and the like are displayed by the OS.

On the first home screen 42A displayed on the display 42, a first status information screen 50 related to a consumable, for example, an ink remaining amount, is displayed as a pop-up. The first status information screen 50 includes a first character string display field 50A in which a character string such as “replace ink soon” is displayed as status information, a second character string display field 50B in which a character string such as “access website containing support information” is displayed and which is linked to an access destination of the server 5, a model name display field 50C in which a model name of the device 1 is displayed, an ink remaining amount display field 50D in which an ink remaining amount is displayed, a sheet remaining amount display field 50E in which a sheet remaining amount is displayed, an offering information display field 50F in which offering information or the like related to the status information displayed in the first character string display field 50A is displayed, a notification list button display field 50G in which a notification list button for displaying a notification list screen is displayed, and the like.

The model name display field 50C displays a model name and an IP address of a corresponding device. Instead of the IP address, other identification information that can uniquely identify the device may be used. As other identification information, for example, a MAC address, a serial number, or the like can be used.

Further, on the first home screen 42A, a second status information screen 51 not related to a consumable, for example, ink, as illustrated in FIG. 3A is displayed as a pop-up by the device monitoring program 33. The second status information screen 51 includes a model name display field 51A in which the model name of the device 1 is displayed, and a second character string display field 51B in which a character string such as “no sheet” is displayed as status information. When the character string “no sheet” is displayed in the second character string display field 51B, the information processing apparatus 200 acquires status information indicating that there is no sheet from the printer 1.

Further, on the first home screen 42A, a third status information screen 52 not related to a consumable, for example, ink, as illustrated in FIG. 3B is displayed as a pop-up by the device monitoring program 33. The third status information screen 52 includes a model name display field 52A in which the model name of the device 1 is displayed, and a progress status display field 52B in which, for example, a scan progress status of the image reading device 1B is displayed as status information.

Further, on the first home screen 42A, an offering information screen 53 that displays offering information or the like as illustrated in FIG. 3C, is displayed as a pop-up by the device monitoring program 33. The offering information screen 53 includes an offering information display field 53A in which offering information is displayed, a notification list button display field 53B in which a notification list button for displaying a notification list screen is displayed, and the like.

The information processing apparatus 200 may be configured such that on the first home screen 42A, the first status information screen 50 that displays the status information related to the consumable, the second status information screen 51 and the third status information screen 52 that display the status information not related to the consumable, and the offering information screen 53 that displays the offering information are displayed as pop-ups not to overlap each other, or these information screens 50 to 52 are overlapped and displayed as pop-ups.

Further, when the information processing apparatus 200 is configured such that a plurality of screens are overlapped and displayed as pop-ups, the information processing apparatus 200 may be configured such that a screen that displays new information is displayed as a pop-up in a foreground. In this case, since the screen that displays the new information is displayed as a pop-up in the foreground, the user can always keep an eye on a latest status of the device and latest information on the device, and acquire the status and the information, enabling a quick response.

### Display of Status Information, Offering Information, and Notification List

FIG. 4 is a sequence diagram illustrating an example of a procedure for displaying the status information, the offering information, and the notification list implemented by the device monitoring program 33 of the information processing apparatus 200, including operations of the device 1 and the server 5.

Each processing step in the present embodiment represents processing of the CPU 21 according to an instruction described in a program such as the device monitoring program 33 of the information processing apparatus 200. The processing by the CPU 21 also includes a hardware control using an API of the OS. In the present specification, a detail description of the OS is omitted, and an operation of each program is described. In addition, in the present specification, for convenience, processing primarily performed by the CPU 21 may be described as being primarily performed by a program or a device.

### Display of Status Information and Offering Information

In FIG. 4, first, in a case in which an error occurs during operation, for example, in a case in which the device 1 is the printer 1A, when a consumable such as ink runs out or an error such as a sheet jam occurs during printing, the device 1 transmits status information indicating error content to the information processing apparatus 200 (procedure 11 (hereinafter, referred to as T11)). Therefore, the information processing apparatus 200 that receives the status information stores the received status information in the data storage unit 35 (T12).

In the information processing apparatus 200, a query for status information is executed on each device 1 connected to the information processing apparatus 200, that is, on each device 1 to be monitored by the device monitoring program 33, that is, on the device 1 having the model name stored in the device table 35A. In other words, the information processing apparatus 200, that is, the device monitoring program 33 queries each device 1 at regular intervals, and a so-called polling is executed (T13). A polling interval for each device 1 may be constant, or may be varied based on, for example, a frequency of use of the device 1. Further, the polling interval may be a polling interval set by the user on a setting screen 80 described later.

Each device 1 that receives the query from the information processing apparatus 200 transmits the status information to the information processing apparatus 200 (T14). Therefore, the device monitoring program 33 that receives the status information stores the received status information in the data storage unit 35 (T15). The processing in T14 is an example of the acquisition processing.

When the status information is stored in the data storage unit 35 in T12 or T15, the device monitoring program 33 determines whether the stored status information is status information related to a consumable such as ink provided by the manufacturer or the sales company of the device 1. If the device monitoring program 33 determines that the status information is status information related to the consumable, as illustrated in FIG. 2, the device monitoring program 33 displays the first status information screen 50 as a pop-up on the first home screen 42A based on content of the status information (T16).

Further, the device monitoring program 33 searches for offering information stored in the data storage unit 35 based on the content of the status information and the model name of the device 1, specifically, for example, warning information “replace ink soon” displayed in the first character string display field 50A and a model name “DCP-XXXDW” displayed in the model name display field 50C, and extracts the offering information stored in association with the warning information and the model name. Then, the information processing apparatus 200 displays the extracted offering information in the offering information display field 50F on the first status information screen 50.

As described above, in the present embodiment, on the first status information screen 50 based on the status information related to the consumable among the status information transmitted from all the devices 1 connected to the information processing apparatus 200, that is, the respective devices 1 to be monitored by the device monitoring program 33, the offering information related to the warning information and the model name is also displayed in the offering information display field 50F, and therefore, by viewing the content displayed as a pop-up, the user can recognize that there is a device 1 having a predetermined status, or that there is offering information related to the status, thereby improving user convenience. Further, an improvement in user ability to cope with the status information can also be expected.

Next, the device monitoring program 33 determines whether the status information stored in the data storage unit 35 is status information related to a consumable such as ink provided by the manufacturer or the sales company of the device 1. If the device monitoring program 33 determines that the status information is not status information related to the consumable provided by the manufacturer or the sales company of the device 1, such as running out of print sheet, the device monitoring program 33 displays the second status information screen 51 as illustrated in FIG. 3A or the third status information screen 52 as illustrated in FIG. 3B as pop-ups on the first home screen 42A based on the content of the status information (T17). The second status information screen 51 is a screen indicating that there is no sheet in the device, and the third status information screen 52 is a screen indicating that scan processing is being executed in the device.

When the device monitoring program 33 receives the same status information from the device 1 while displaying a screen based on certain status information from the device 1 as a pop-up, the device monitoring program 33 may omit further displaying a screen based on the received status information as a pop-up. The processing in T16 and T17 are examples of the notification processing.

Next, as illustrated in FIG. 2, in a state in which the device monitoring program 33 displays the first status information screen 50 as a pop-up, when a list button 50H portion displayed on a right side of the model name display field 50C is clicked with the mouse 41 to instruct a display of pull-down (T18), the device monitoring program 33 displays a menu 50J below the model name display field 50C as illustrated in FIG. 5 (T19). The list menu displays model names and IP addresses of all the devices 1 to be monitored by the device monitoring program 33, that is, model names and IP addresses of the devices stored in the device table 35A, respectively.

At this time, the model name display field 50C and the menu 50J each display a status mark 50K corresponding to the model name displayed therein. The status mark 50K is displayed based on the status information stored in the data storage unit 35.

Here, when the user clicks and selects a new model name portion displayed in the menu 50J with the mouse 41 (T20), the device monitoring program 33 displays another model name newly selected by the user in the model name display field 50C, reads the status information and the offering information corresponding to the model name newly selected by the user from the data storage unit 35, and displays the status information and the offering information as the first status information screen 50 (T21).

At this time, even if the user selects another model name displayed in the menu 50J by the device monitoring program 33 in the processing in T20, the device selected in the device control program 34 is not changed, and for example, the model name displayed in a model name display field 73 on the second home screen 70 illustrated in FIG. 9 described later is not changed.

The device monitoring program 33 displays the first status information screen 50 to notify a device to be monitored, and the user can switch the model name display field 50C to check a status of another device. On the other hand, the device control program 34 selects a device to be controlled, and when the same device is continuously used, there is no need to reselect the device to be controlled. Therefore, if the device controlled by the device control program 34 is switched in link with switching of the device being monitored by the device monitoring program 33, the user who continues to use the same device needs to restore the device to be controlled. Therefore, it is more convenient for the user when the device 1 set in the model name display field 50C and the device 1 set in the model name display field 73 on the second home screen 70 are not linked with each other, as in the present embodiment.

Further, in the present embodiment, even for another model name displayed in the menu 50J, by clicking and selecting another model name with the mouse 41, status information and offering information corresponding to the another model name can be displayed as the first status information screen 50, and thus latest status information and offering information on the device 1 required by the user can be provided, improving user convenience.

Further, in the present embodiment, the model name display field 50C and the menu 50J each display the status mark 50K corresponding to the model name displayed therein, which assists the user in selecting another model name displayed in the menu 50J or the like, thereby improving convenience. Further, the device monitoring program 33 queries the server 5 connected to the information processing apparatus 200 for offering information, that is, the information processing apparatus 200 performs a polling on the server 5 (T22). The query is accompanied by information indicating a time of a previous query. When offering information not transmitted to the information processing apparatus 200 is present, that is, new offering information registered after a time indicated by the accompanied information is present, the server 5 that receives the query transmits the new offering information to the information processing apparatus 200 (T23). Therefore, the information processing apparatus 200 that receives the offering information stores the received offering information in the data storage unit 35 which is accessible by the device control program 34 (T24).

A polling interval for the server 5 may be the same as the polling interval for each device 1 performed by the device monitoring program 33, or the polling intervals for the device 1 and the server 5 may be different. For example, the polling interval for the server 5 may be set longer than the polling interval for the device 1. Further, the polling interval for the server 5 may be changed based on circumstances such as a season or presence or absence of an event. Further, the polling interval may be a polling interval set by the user on the setting screen 80 described later.

Next, the device monitoring program 33 searches for offering information stored in the data storage unit 35, and when newly arrived offering information is present, the device monitoring program 33 displays the offering information screen 53 as illustrated in FIG. 3C as a pop-up on the first home screen 42A based on the newly arrived offering information (T25). That is, similarly to the first status information screen 50 related to the status information, the device monitoring program 33 displays the offering information screen 53 related to the offering information as a pop-up.

In this processing, when no newly arrived offering information is present, the device monitoring program 33 may display the offering information screen 53 as a pop-up based on latest offering information. Further, when no newly arrived offering information is present and the first status information screen 50 is displayed, the device monitoring program 33 may search for offering information stored in the data storage unit 35 based on the model name displayed in the model name display field 50C on the first status information screen 50, and may display the offering information screen 53 as a pop-up on the first home screen 42A based on the extracted offering information.

### Display of Notification List

Next, in a state in which the information processing apparatus 200 displays the status information screen 50 or displays the offering information screen 53, when the user clicks a notification list button portion displayed in the notification list button display field 50G on the first status information screen 50 or the notification list button display field 53B on the offering information screen 53 with the mouse 41 (T31), the device monitoring program 33 instructs the device control program 34 to activate and display a notification list screen 54 (T32).

Then, as illustrated in FIG. 6, the activated device control program 34 displays all notifications for the monitored device 1 on the display 42 as the notification list screen 54, based on the notification information stored in the data storage unit 35 (T33).

The notification list screen 54 displays notification objects 54A to 54D. Further, each of the notification objects 54A to 54D displays a notification date, a notification message, a target model name, and the like. Then, when a click operation with the mouse 41 on each of the objects 54A to 54D is received, a detailed information screen or a reference information screen is displayed.

The device control program 34 refers to the offering information stored in the data storage unit 35 by the device monitoring program 33 in T24, and displays the notification list screen 54 based on the referred offering information. In FIG. 8 described later, even when the user clicks a “notification list” tab 83A portion with the mouse 41, the notification list screen 54 can be displayed on the setting screen 80.

Further, in a state in which the device monitoring program 33 displays the first status information screen 50, when the user clicks a character portion or an illustration portion displayed in the offering information display field 50F with the mouse 41 (T34), the device monitoring program 33 instructs the device control program 34 to activate and display a detailed information screen or a reference information screen (not illustrated) (T35). Then, the activated device control program 34 displays the detailed information screen and the reference information screen on the display 42 based on the notification information stored in the data storage unit 35 (T36).

In a state in which the offering information screen 53 is displayed, when the user clicks a character portion or an illustration portion displayed in the offering information display field 53A with the mouse 41 (T34), the device monitoring program 33 instructs the device control program 34 to activate and display a detailed information screen or a reference information screen (not illustrated) (T35). The activated device control program 34 displays the detailed information screen and the reference information screen on the display 42 based on the notification information stored in the data storage unit 35 (T36).

As described above, in the present embodiment, since the notification information for all the devices 1 monitored by the device monitoring program 33 is stored in the data storage unit 35, and the device control program 34 displays the notification list screen 54, the detailed information screen, and the reference information screen on the display 42 based on the notification information stored in the data storage unit 35, the user can properly understand the offering information currently provided to the device 1.

When a function of displaying a screen corresponding to the notification list screen 54 is implemented in the resident device monitoring program 33, a large amount of resources is consumed for that screen, regardless of whether the screen is being displayed while the device monitoring program 33 is activated. However, in the present embodiment, since the non-resident device control program 34 allows the device monitoring program 33 to display the notification list screen 54, and does not allow the resident device monitoring program 33 to implement the function of displaying the screen corresponding to the notification list screen 54, the amount of resources used by the resident device monitoring program 33 can be reduced.

In the present embodiment, the device monitoring program 33 is configured, in response to a display instruction, to display the notification list screen 54, the detailed information screen, the reference information screen, and the like on the display 42 based on the notification information stored in the data storage unit 35. However, the device monitoring program 33 may also be configured, in response to a display instruction (T31, T34), to access the server 5 and display the notification list screen 54, the detailed information screen, the reference information screen, and the like on the display 42 based on latest notification information downloaded therefrom (T33, T36). With this configuration, the user can view the latest notification list screen 54, the detailed information screen, the reference information screen, and the like related to the device 1, and can prevent an erroneous operation based on old information.

### Various Setting Processing

Next, FIG. 7 is a sequence diagram illustrating an example of a procedure for various setting processing implemented by the device monitoring program 33 and the device control program 34 of the information processing apparatus 200, including operations of the device 1. Hereinafter, details of the various setting processing will be described with reference to FIG. 7.

Each processing step in the present embodiment represents processing of the CPU 21 according to an instruction described in a program such as the device monitoring program 33 of the information processing apparatus 200. The processing by the CPU 21 also includes a hardware control using an API of the OS. In the present specification, a detail description of the OS is omitted, and an operation of each program is described. In addition, in the present specification, for convenience, processing primarily performed by the CPU 21 may be described as being primarily performed by a program or a device.

That is, as illustrated in FIG. 8, when the user clicks a box display button 45 portion displayed in a notification area of the taskbar 44 displayed on the display 42 with the mouse 41 to instruct a display of a box (T41), the device monitoring program 33 displays a box 60 on the display 42, and displays, within the box 60, a first icon 61 and a first badge 62 of the device monitoring program 33, which is a resident program, respectively (T42). The box 60 is an area in which icons of resident programs can be displayed, and can also be referred to as an icon display area.

The device monitoring program 33 changes a display method of the first badge 62 based on a type of information acquired from the monitored device, for example, the device 1 or the server 5 via the network interface 27. However, a detail description of the display method of the first badge 62 will be omitted here.

Next, when the user clicks a first icon 61 portion with the mouse 41 to instruct a display of an activation box 63 (T43), the device monitoring program 33 displays the activation box 63 on the display 42 (T44).

In the activation box 63, characters 63A “activate control program”, characters 63B “notification setting”, characters 63C “notification list”, characters 63D “device setting”, and the like are displayed, respectively.

Here, when the user clicks a portion of the characters 63A “activate control program” in the activation box 63 with the mouse 41 to instruct activation of the device control program 34 (T45), the device monitoring program 33 activates the device control program 34 (T46).

The device control program 34 can also be activated by the user clicking an icon 43 portion displayed on the first home screen 42A with the mouse 41. Further, a shortcut icon for activating the device control program 34 may be provided in the taskbar 44.

When the user clicks a portion of the characters 63B “notification setting” with the mouse 41, the device monitoring program 33 instructs the device control program 34 to display a notification setting screen 80A described later. When the user clicks a portion of the characters 63C “notification list” with the mouse 41, the device monitoring program 33 instructs the device control program 34 to display the notification list screen 54. When the user clicks a portion of characters 63D “device setting” with the mouse 41, the device monitoring program 33 instructs the device control program 34 to display a device list screen 85 described later.

When the device control program 34 is activated, the device control program 34 displays the second home screen 70 of the device control program 34 on the display 42 (T47).

FIG. 9 is a diagram illustrating an example of the display 42 in a state in which the second home screen 70 displayed by the device control program 34 is displayed.

As illustrated in FIG. 9, a print icon 71, a scan icon 72, a setting button 78, a “device addition” button 79, and the like are displayed on the second home screen 70. The second home screen 70 includes a model name display field 73, a status information display field 74, and an ink remaining amount display field 75.

The print icon 71 is used when a device to be controlled is caused to perform printing. The scan icon 72 is used when a device to be controlled is caused to perform image reading. The model name display field 73 displays a name of the device 1 to be controlled by the device control program 34, specifically, a model name of the device 1.

The model name display field 73 is configured with a pull-down menu, and when the user clicks a list button 73A portion with the mouse 41, a menu (not illustrated) is displayed below the model name display field 73. The menu displays the model names of all the devices 1 to be monitored by the device monitoring program 33, that is, the model names and the IP addresses stored in the device table 35A.

The print icon 71 and the scan icon 72 are displayed based on a capability of a device selected to be controlled. That is, when the device displayed in the model name display field 73 has a printing function, the print icon 71 is displayed as operable, whereas when the device does not have a printing function, the print icon 71 is not displayed as operable. When the device displayed in the model name display field 73 has an image reading function, the scan icon 72 is displayed as operable, whereas when the device does not have an image reading function, the scan icon 72 is not displayed as operable.

When the user clicks any one of the model name portions displayed in the list menu with the mouse 41, the clicked new model name is displayed in the model name display field 73, and the device 1 to be controlled by the device control program 34 is changed.

At this time, even if the model name displayed in the model name display field 73 is changed by the user and the device 1 to be controlled by the device control program 34 is changed, the model name displayed in the model name display field 50C is not changed in a state in which the first status information screen 50 is displayed as a pop-up.

The model name display field 73 on the second home screen 70 for setting a device 1 to be controlled and the model name display field 50C for setting a device 1 whose status is checked are often used for different devices 1, respectively. Therefore, it is more convenient for the user when the device 1 set in the model name display field 73 of the second home screen 70 and the device 1 set in the model name display field 50C are not linked with each other, as in the present embodiment.

The status information display field 74 displays the status information on the device 1 displayed in the model name display field 73. When the device 1 displayed in the model name display field 73 is the printer 1A, the ink remaining amount display field 75 displays an ink remaining amount of the printer 1A. When the device control program 34 is activated, as illustrated in FIG. 9, a second icon 76 and a second badge 77 of the device control program 34 are displayed in the taskbar 44 on the first home screen 42A (T48). The device control program 34 displays, in the second badge 77, the number of unread offering information among the offering information for all the devices 1 to be monitored by the device monitoring program 33, which is stored in the data storage unit 35. That is, the second badge 77 illustrated in FIG. 9 indicates a state in which 20 pieces of unread offering information related to all the devices 1 to be monitored by the device monitoring program 33 are present. The icon 76 displayed in the taskbar 44 is larger in size than the icon 61 displayed in the box 60. Therefore, the icon 76 can display a badge indicating how many pieces of unread offering information are present.

Returning to the sequence diagram illustrating an example of the procedure for display processing of the status information and offering information illustrated in FIG. 7, when the user clicks a setting button 78 portion illustrated in FIG. 9 with the mouse 41 to instruct a display of a setting screen (T49), the device control program 34 displays the setting screen 80, on which the notification setting screen 80A is displayed, on the display 42 as illustrated in FIG. 10 (T50). This processing is an example of the display processing. The setting button 78 is an example of an operation object.

On the setting screen 80, an activation timing setting field 81 for setting an activation timing of the device monitoring program 33, an offering information setting field 82 for setting a type of offering information provided to the user, and the like are displayed. The activation timing setting field 81 displays a first radio button 81A for always activating the device monitoring program 33 when the information processing apparatus 200 is activated, that is, for setting the device monitoring program 33 to a resident program, and a second radio button 81B for activating the device monitoring program 33 when the device control program 34 is activated, that is, for setting the device monitoring program 33 to a non-resident program.

The offering information setting field 82 on the setting screen 80 displays a third radio button 82A for setting to agree to receive offering information and a fourth radio button 82B for setting not to receive offering information. Below the third radio button 82A, a first check box 82C and a second check box 82C for selecting a type of offering information to be received are displayed.

When the user clicks a first radio button 81A portion with the mouse 41 (T51), the device control program 34 executes reception processing for a setting change (T52). Thereafter, the device control program 34 passes a setting change notification to the device monitoring program 33 (T53). Then, the device monitoring program 33 that receives the setting change notification sets itself to a resident program (T54). “Passing a setting change notification to the device monitoring program 33” may be referred to as “transmitting a setting change notification to the device monitoring program 33” or “storing a setting change notification in a storage area accessed by the device monitoring program 33”. The same applies to the description related to T53 or the like described later.

When the user clicks a second radio button 81B portion with the mouse 41 (T51), the device control program 34 executes reception processing for the setting change (T52). Thereafter, the device control program 34 transmits a setting change notification to the device monitoring program 33 (T53). Then, the device monitoring program 33 that receives the setting change notification performs a setting change of the setting information stored in the data storage unit 35 and sets itself to a non-resident program (T54).

When the user clicks a third radio button 82A portion with the mouse 41 and then clicks the first check box 82C and a first check box 82C portion with the mouse 41 to set a type of offering information to be received (T51), the device control program 34 executes reception processing for the setting change (T52).

Thereafter, the device control program 34 passes a setting change notification to the device monitoring program 33 (T53). Then, the device monitoring program 33 that receives the setting change notification displays offering information in offering information display field 50F on the first status information screen 50 and the offering information display field 53A on the offering information screen 53 according to the type of offering information to be received, which is set by the user.

When the user clicks a fourth radio button 82B portion with the mouse 41 to set not to receive the offering information (T51), the device control program 34 executes reception processing for the setting change (T52).

Thereafter, the device control program 34 passes a setting change notification to the device monitoring program 33 (T53). Then, the device monitoring program 33 that receives the setting change notification does not display the offering information in the offering information display field 50F on the first status information screen 50 and the offering information display field 53A on the offering information screen 53 according to the setting by the user.

As described above, in the present embodiment, by setting the type of offering information or the like desired by the user to be downloaded in the offering information setting field 82, the offering information or the like desired by the user can be provided, and only the offering information desired by the user can be efficiently provided to the user.

In the present embodiment, the setting screen 80 is configured such that the activation timing of the device monitoring program 33 can also be set, and a monitoring interval time of the device 1 by the device monitoring program 33, a selection of the device 1 to be monitored, or the like may be set. Further, when there are a plurality of types of notification modes of status information by the device monitoring program 33, the notification mode may also be set.

In general, when the resident device monitoring program 33 provides the setting screen 80, a large amount of resources is consumed for that screen at all times, regardless of whether the screen is being displayed. However, in the present embodiment, since the non-resident device control program 34 displays the setting screen 80 for the resident device monitoring program 33, and the resident device monitoring program 33 does not provide the setting screen 80, the amount of resources used by the resident device monitoring program 33 reduced.

Next, when the user clicks a “managed device list” tab 83C on the setting screen 80 with the mouse 41 to instruct a display of a device list screen (T55), the information processing apparatus 200 (device control program 34) displays the device list screen 85 on the setting screen 80 based on the model name stored in the device table 35A stored in the data storage unit 35 (T56). A “tab” is a type of object that receives an operation. When a “notification setting” tab 83B is clicked in a state in which the device list screen 85 is displayed on the setting screen 80, the device control program 34 displays the notification setting screen 80A on the setting screen 80.

As illustrated in FIG. 11, the device list screen 85 includes a currently selected model name display field 86 and an other model name display field 87. The currently selected model name display field 86 displays a model name displayed in the model name display field 73 illustrated in FIG. 9, that is, a model name and an IP address of the device 1 to be controlled by the device control program 34. The other model name display field 87 displays model names of the devices 1 to be monitored by the device monitoring program 33, that is, other model names and IP addresses, excluding the model name displayed in the currently selected model name display field 86, among the model names stored in the device table 35A. Further, the other model name display field 87 includes a “delete” button 88 corresponding to each displayed model name.

Here, when the user clicks any one of “delete” button 88 portions with the mouse 41 to instruct device deletion (T57), the device control program 34 executes reception processing for the deletion of the managed device (T58). That is, the device control program 34 deletes the model name and the IP address for which the deletion instruction was issued from the list menu displayed below the model name display field 73.

At this time, in the present embodiment, since the currently selected model name display field 86 does not include a “delete” button, the user can be prevented from erroneously deleting the model name of the device 1 to be controlled by the device control program 34.

Thereafter, the device control program 34 instructs the device monitoring program 33 to delete the managed device (T59). Then, the device monitoring program 33 that receives the setting change notification deletes a specific model name and an IP address specified by the model name and the IP address for which the deletion instruction was issued, among the model names stored in the device table 35A stored in the data storage unit 35 (T60). Thereafter, the device monitoring program 33 executes a monitoring operation on the device 1 based on the new device table 35A excluding the model name for which the deletion instruction was issued (T61). That is, this is reflected in the processing in T13 to T15 illustrated in FIG. 4.

In general, when the resident device monitoring program 33 provides the device list screen 85, a large amount of resources is consumed for that screen at all times, regardless of whether the screen is being displayed. However, in the present embodiment, since the non-resident device control program 34 displays the device list screen 85, and the resident device monitoring program 33 does not provide the device list screen 85, the amount of resources used by the resident device monitoring program 33 can be reduced.

Next, when the user clicks an “add device” button 79 portion displayed on the second home screen 70 illustrated in FIG. 9 with the mouse 41 to instruct a display of a device addition screen (T62), the device control program 34 displays a device addition screen 90 on the display 42 (T63).

As illustrated in FIG. 12, the device addition screen 90 includes an additional device display field 91, and displays a “device search” button 92, an “OK” button 93, and the like. The additional device display field 91 displays a list of model names and IP addresses of all the devices 1 connected to the information processing apparatus 200.

Here, when the user clicks a “device search” button 92 portion with the mouse 41, the device control program 34 searches for the device 1 connected to the information processing apparatus 200 and then displays the model names of all the searched devices in the additional device display field 91.

When the user clicks any one of the model names displayed in the additional device display field 91 with the mouse 41 and then clicks an “OK” button 93 with the mouse 41 to instruct device addition (T64), the device control program 34 executes reception processing for the device addition (T65). That is, the device control program 34 adds the added model name and IP address to the list menu displayed below the model name display field 73.

Thereafter, the device control program 34 instructs the device monitoring program 33 to add a device (T66). Then, the device monitoring program 33 that receives a device addition notification adds a model name and an IP address of the device for which the addition instruction was issued, to the device table 35A stored in the data storage unit 35 (T67). Thereafter, the device monitoring program 33 executes a monitoring operation on the device 1 based on the new device table 35A to which the new model name and IP address are added (T68). That is, this is reflected in the processing in T13 to T15 illustrated in FIG. 4.

In general, when the resident device monitoring program 33 provides the device addition screen 90, a large amount of resources is consumed for that screen at all times, regardless of whether the screen is being displayed. However, in the present embodiment, since the non-resident device control program 34 displays the device addition screen 90, and the resident device monitoring program 33 does not provide the device addition screen 90, the amount of resources used by the resident device monitoring program 33 can be reduced.

As described above in detail, according to the technique disclosed in the present specification, separate from the resident device monitoring program 33 that acquires status information related to a device, by causing the non-resident device control program 34 capable of transmitting an execution instruction to a device to include a setting screen for the device monitoring program 33, the amount of resources consumed by the device monitoring program 33 can be reduced and resources for displaying a setting screen for making a setting related to the device monitoring program 33 can be efficiently used, compared with a case of causing the device monitoring program 33 to include the setting screen.

Further, since the setting screen for the resident device monitoring program 33 is separated from the device monitoring program 33, the amount of resources consumed by the device monitoring program 33 is less likely affected even if the setting screen is complicated. Therefore, a rich setting screen for the device monitoring program 33 can be provided.

In addition, when the setting screen for the resident device monitoring program 33 supports multiple languages, it is necessary to provide a setting screen for each language. Therefore, if the device monitoring program 33 includes a setting screen, a size of the device monitoring program 33 is likely to increase, and the amount of resources consumed is likely to increase. By separating the setting screen for the device monitoring program 33 from the device monitoring program 33, the effect of reducing the amount of resources consumed is remarkable.

By providing a program set including the resident device monitoring program 33 and the non-resident device control program 34 as one package, the non-resident device control program 34 can be instructed to execute image processing, and the amount of resources consumed by the resident device monitoring program 33 can be reduced.

The program set including the device management program 33 and the device control program 34 may not be provided as one package. For example, the device monitoring program 33 and the device control program 34 may be provided as separate programs, and after both programs are installed in the OS 31, both programs may be used as a program set to perform the above cooperative processing.

The present embodiment is merely an example, and does not limit the present disclosure. Therefore, various improvements and modifications can be naturally made to the present disclosure without departing from the scope thereof. For example, the printer 1A may not include the operation panel 13. The information processing apparatus 200 is not limited to the non-volatile memory 24, and may include any type of large-capacity storage device.

Further, in the processing in T12, when the information processing apparatus 200 receives highly urgent status information such as a sheet jam, the information processing apparatus 200 may be configured to immediately display any one of the first to third status information screens 50 to 52 on the display 42 based on the received status information to notify the user.

The communication method between the printer 1A and the information processing apparatus 200 is not limited to wireless communication conforming to the Wi-Fi (registered trademark) standard. For example, the communication method may be wired communication using a USB cable or wireless communication based on other standards such as Bluetooth (registered trademark). Further, a plurality of communication functions may be provided.

The processing disclosed in the embodiment may be executed by hardware such as a single CPU, a plurality of CPUs, an ASIC, or a combination thereof. In addition, the processing disclosed in the embodiment can be implemented in various modes such as a recording medium in which a program for executing the processing is recorded, or a method.

What is claimed is:

1. A non-transitory computer readable storage medium storing a program set, the program set comprising a first program and a second program, the first program being a resident program, the second program being a non-resident program,
wherein the second program, when executed by a processor of an information processing apparatus, causes the information processing apparatus to perform second operations, the second operations comprising:
transmitting, to an image processing device via a communication device of the information processing apparatus, an execution instruction for causing a job related to image processing to be executed; and
displaying a setting screen configured to receive a setting related to the first program, and
wherein the first program, when executed by the processor, causes the information processing apparatus to perform first operations, the first operations comprising:
communicating, in accordance with the setting received on the setting screen displayed in the second operations, with the image processing device via the communication device;
acquiring information related to the image processing device through a communication with the image processing device; and
displaying notification information based on the information related to the image processing device acquired in the acquiring the information related to the image processing device.

2. The non-transitory computer readable storage medium according to claim 1, wherein the first operations comprise:
displaying an icon corresponding to the first program in a predetermined area in which one or more icons of respective one or more resident programs are allowed to be displayed; and
activating the second program to execute the displaying the setting screen in response to a predetermined operation received via the icon corresponding to the first program.

3. The non-transitory computer readable storage medium according to claim 1, wherein the second operations comprise:
displaying a screen in which an operation object is displayed, the operation object being configured to receive a display instruction of the setting screen; and
executing the displaying the setting screen in response to receipt of an operation on the operation object.

4. The non-transitory computer readable storage medium according to claim 1,
wherein the setting related to the first program, received on the setting screen displayed in the second operations, includes a setting as to whether to make the first program resident,
wherein in a case in which a setting to make the first program resident is made, the first program is activated upon activation of the information processing apparatus and is resident, and
wherein in a case in which a setting not to make the first program resident is made, the first program is not activated upon activation of the information processing apparatus.

5. The non-transitory computer readable storage medium according to claim 1,
wherein in the acquiring the information related to the image processing device in the first operations, a status of the image processing device is acquired as the information related to the image processing device, and
wherein in the displaying the notification information in the first operations, status information based on the status of the image processing device is displayed as the notification information.

6. The non-transitory computer readable storage medium according to claim 5,
wherein the first program, when executed by the processor, allows a plurality of image processing devices to be set as a monitoring target,
wherein the setting received on the setting screen displayed in the second operations includes a setting of an image processing device to be set as the monitoring target,
wherein in the displaying the setting screen in the second operations, an adding operation for adding an image processing device to the monitoring target is allowed to be received via the setting screen, and
wherein the acquiring the information related to the image processing device in the first operations comprise, in a case in which a first image processing device is added to the monitoring target by the adding operation, starting communication, via the communication device, with the first image processing device added to the monitoring target, and acquiring the status from the first image processing device.

7. The non-transitory computer readable storage medium according to claim 6,
wherein in the displaying the setting screen in the second operations, an excluding operation for excluding an image processing device from the monitoring target is allowed to be received via the setting screen, and
wherein the acquiring the information related to the image processing device in the first operations comprise, in a case in which a second image processing device is excluded from the monitoring target by the excluding operation, stopping communication, via the communication device, with the second image processing device excluded from the monitoring target.

8. The non-transitory computer readable storage medium according to claim 6,
wherein the first operations further comprise displaying a first selection screen configured to receive a selection of one of image processing devices set as the monitoring target, and the displaying the notification information in the first operations comprises displaying the status information on the one of image processing devices selected on the first selection screen,
wherein the second operations further comprise displaying a second selection screen configured to receive a selection of one of image processing devices set as the monitoring target, and the transmitting the execution instruction comprises transmitting, to the one of image processing devices selected on the second selection screen via the communication device, the execution instruction for causing the job related to image processing to be executed,
wherein in the first operations, the one of image processing devices selected on the first selection screen is not changed even in a case in which the one of image processing devices selected on the second selection screen in the second operations is changed, and
wherein in the second operations, the one of image processing devices selected on the second selection screen is not changed even in a case in which the one of image processing devices selected on the first selection screen in the first operations is changed.

9. The non-transitory computer readable storage medium according to claim 1,
wherein the acquiring the information related to the image processing device in the first operations comprises:
communicating, in accordance with the setting received on the setting screen displayed in the second operations, also with a server via the communication device, the server being configured to provide service-related information related to a service available to the image processing device; and
acquiring the service-related information as the information related to the image processing device through a communication with the server, and
wherein the displaying the notification information in the first operations comprises displaying the service-related information as the notification information.

10. The non-transitory computer readable storage medium according to claim 9,
wherein the first operations further comprise storing, in a memory of the information processing apparatus, the service-related information acquired in the acquiring the service-related information, the memory being configured to store a plurality of pieces of the service-related information, and
wherein the second operations further comprise:
reading the service-related information stored in the memory; and
displaying a list of the service-related information read from the memory.

11. A non-transitory computer readable storage medium storing a program set, the program set comprising an acquisition program and a display program, the acquisition program being a resident program, the display program being a non-resident program,
wherein the acquisition program, when executed by a processor of an information processing apparatus, causes the information processing apparatus to perform first operations, the first operations comprising:
communicating with a server via a communication device of the information processing apparatus, the service-related information being related to a service available to an image processing device, the server being configured to provide the service-related information;
acquiring the service-related information through a communication with the server; and
storing, in a memory of the information processing apparatus, the service-related information acquired in the acquiring the service-related information, the memory being configured to store a plurality of pieces of the service-related information, and
wherein the display program, when executed by the processor, causes the information processing apparatus to perform second operations, the second operations comprising:
reading the service-related information stored in the memory; and
displaying a list of the service-related information read from the memory.

12. An information processing apparatus comprising:
a communication device;
a processor; and
a memory storing a program set, the program set comprising a first program and a second program, the first program being a resident program, the second program being a non-resident program,
wherein the second program, when executed by the processor, causes the information processing apparatus to perform second operations, the second operations comprising:
transmitting, to an image processing device via the communication device, an execution instruction for causing a job related to image processing to be executed; and
displaying a setting screen configured to receive a setting related to the first program, and
wherein the first program, when executed by the processor, causes the information processing apparatus to perform first operations, the first operations comprising:
communicating, in accordance with the setting received on the setting screen displayed in the second operations, with the image processing device via the communication device;
acquiring information related to the image processing device through a communication with the image processing device; and
displaying notification information based on the information related to the image processing device acquired in the acquiring the information related to the image processing device.
